(19) United States
(12) Patent Application Publication
(10) Pub. No.: US 2007/0263240 A1
(43) Pub. Date: Nov. 15, 2007

(54) Image-Forming Apparatus, Image-Forming Control Method, Image-Forming Control Program Storage Medium, Image-Forming Control Data Signal, And Image-Forming Control Apparatus

(75) Inventor: Norihisa Hirai, Kanagawa (JP)

Correspondence Address: GAUTHIER & CONNORS, LLP, 225 FRANKLIN STREET, SUITE 2300, BOSTON, MA, 02110, US

(73) Assignee: FUJI XEROX CO., LTD., Tokyo (JP)

(21) Appl. No.: 11/611,237

(22) Filed: Dec. 15, 2006

(30) Foreign Application Priority Data
May 10, 2006 (JP) 2006-131226

(51) Int. Cl. G06K 15/02

(52) U.S. Cl. 358/1.11

(57) ABSTRACT

An image-forming apparatus includes an image output unit that outputs an image, wherein the image output unit has its output controlled with output target indication data that indicate a file capable of embedding a font as an output target, auxiliary output target indication data that indicate an attribute value related to the file as an auxiliary output target, and font indication data that indicate the font embedded in the file as a font used for outputting the attribute value.

### PRIORITY INFORMATION

This application claims priority from Japanese Patent Application No. 2006-131226, filed on May 10, 2006.

### BACKGROUND

1. Technical Field

The present invention generally relates to a technique of outputting electronic data, and more particular to a technique of setting a font for output.

2. Related Art

A structured electronic file such as a PDF (Portable Document Format) file can embed a font therewithin. Therefore, even if a printer for print output or a display apparatus for display output does not have all of the corresponding fonts, usage of the embedded font enables printing or displaying of the same design as intended by a file creator.

### SUMMARY

According to an aspect of the invention, there is provided an image-forming apparatus including an image output unit that outputs an image, wherein the image output unit has its output controlled with output target indication data that indicate a file capable of embedding a font therein as an output target, auxiliary output target indication data that indicate an attribute value related to the file as an auxiliary output target, and font indication data that indicate the font embedded in the file as a font used for outputting the attribute value.

### BRIEF DESCRIPTION OF THE DRAWINGS

Exemplary embodiment(s) of the present invention will be described by reference to the following figures, wherein:

FIG. 1 is a block diagram illustrating a system configuration according to this exemplary embodiment;

FIG. 2 is a flowchart showing a process flow in a printer;

FIG. 3 shows an example of a PDF document of a print target;

FIG. 4 shows an example of a job ticket;

FIG. 5 shows an example of banner printing; and

FIG. 6 shows an example of stamp printing.

### DETAILED DESCRIPTION

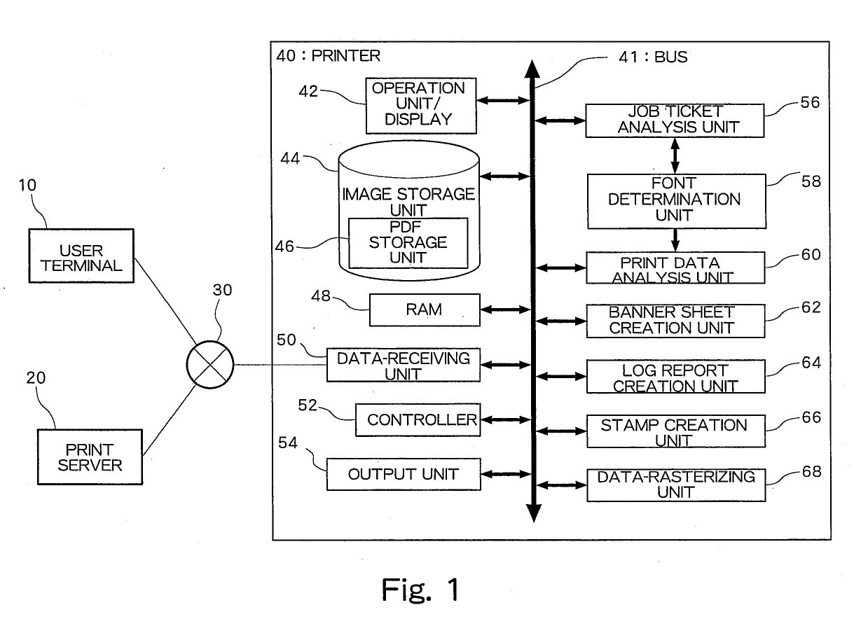

FIG. 1 illustrates a system configuration according to this exemplary embodiment. This system includes a user terminal 10 as a client, a print server 20 that accepts a print request from the user terminal, and a printer 40 that executes printing in accordance with an instruction from the print server 20, all of which are connected to a network 30 such as the Internet.

The user terminal 10 is constructed by installing print request software in a PC (personal computer). The user terminal 10 is an apparatus operated by a user, which, in response to the user's operation, performs the print request for print data such as a PDF document and the like with respect to the print server 20. The print request or a print setting for the PDF document is typically performed by sending print control data referred to as a “job ticket.” Various print control data can be described in the job ticket, including designation of the number of copies to be printed, designation of single-sided or double-sided printing, Nup (N-page data are reductively printed on the same paper) designation, and the like. It should be noted that the PDF document serving as a print target may be sent to the print server 20 with the job ticket, or may be obtained from its storage location by the print server 20 by reference to storage location information (a URL and the like) described in the job ticket.

The user terminal 10 can simply fulfill the print request for the print data by using the job ticket, and can also fulfill an auxiliary print request. Illustrative examples of the auxiliary print request may include a print request for a banner sheet, a print request for a log report, and a print request for a stamp superimposed in the PDF document. In the auxiliary print request, an attribute value for the PDF document (a file name, a print requestor's user name, or the like) is typically set as the print target, and further a font used for printing the attribute value is set by reference to a font embedded in the PDF document. These settings are performed by editing the job ticket in accordance with the user's instruction or on the basis of programmed settings.

The print server 20 is an apparatus constructed by installing print control software in the PC or a workstation. The print server 20 accepts the job ticket from the user terminal 10, analyzes it and issues a print instruction to the printer 40 that should perform the printing. The print instruction is typically issued by sending the job ticket and the print data. It should be noted that the system may also be configured to issue the print instruction directly from the user terminal 10 to the printer 40, without the print server 20 being provided.

The printer 40 is an apparatus that prints an image on paper. The printer is provided with a bus 41 as an internal communication path, and various components are connected to this bus 41. An operation unit/display 42 is a user interface provided with a display. An image storage unit 44 includes a storage device such as a hard disk, and can store image data for a long time. The image storage unit 44 is also provided with a PDF storage unit 46 that saves PDF documents. Generally, although a PDF document subjected to the print instruction is not stored in the PDF storage unit 46, the PDF document is stored in this PDF storage unit 46 when required for creating the log report.

RAM 48 is used for temporarily storing programs, the print data, and the like. A data-receiving unit 50 is connected to the network 30 and receives the job ticket or the PDF document from the print server 20. A controller 52 is provided with a CPU and controls all the operations of the printer 40. An output unit 54 is an apparatus that prints rasterized images on the paper.

A job ticket analysis unit 56 reads the job ticket received by the data-receiving unit 50, and analyzes how to perform the printing of the PDF document, whether an auxiliary print request is present, and the like. As a result of the analysis, if the auxiliary print request is present and the font embedded in the PDF document is set to be used for printing the attribute value, a font determination unit 58 and a print data analysis unit 60 refer to the font. Specifically, the font determination unit 58 queries whether or not the font described in the job ticket is included, with respect to the print data analysis unit 60 that analyzes the PDF document. Then, if the font is included, the font determination unit 58 determines to use the font. If the font is not included, the font determination unit 58 determines a font to be alternatively used, in accordance with the setting in the job ticket or a previously programmed setting.

A banner sheet creation unit 62, a log report creation unit 64, and a stamp creation unit 66 create any banner sheet, log report, or stamp to be synthesized with the PDF document, respectively. These creations typically use the font determined by the font determination unit 58. A data-rasterizing unit 68 generates a raster image interpretable by the output unit 54 that is to print the PDF document, the banner sheet, or the like.

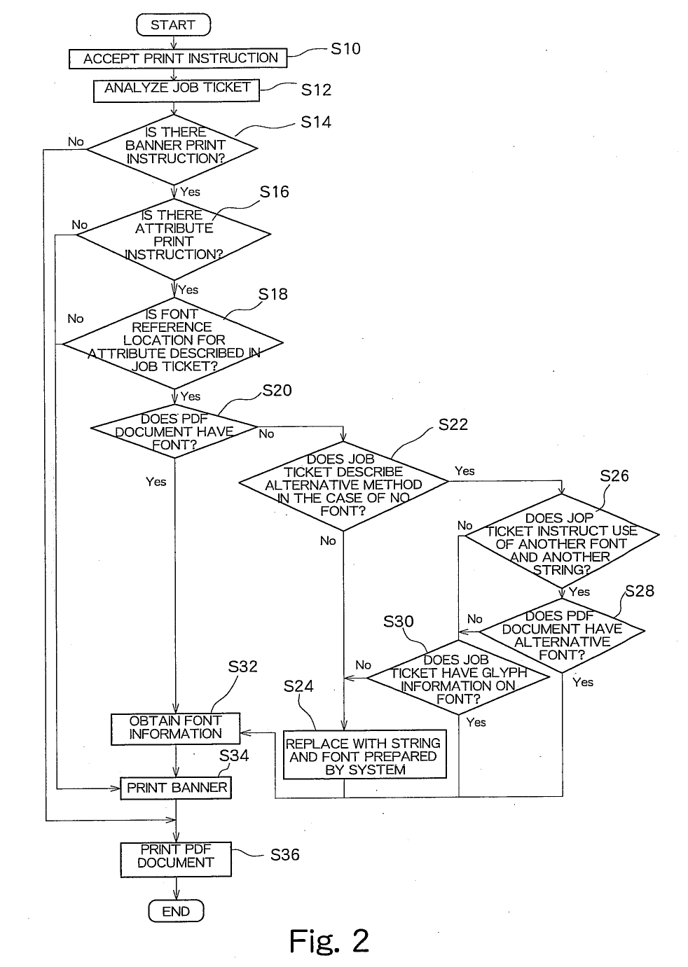

Next, by reference to FIG. 2, a process flow in the printer 40 illustrated in FIG. 1 will be described. FIG. 2 is a flowchart showing the process flow in the case considering only banner printing as the auxiliary print request.

When the data-receiving unit 50 of the printer 40 receives the job ticket and the PDF document from the print server 20 and accepts the print instruction (S10), the job ticket analysis unit 56 analyzes the job ticket (S12). Specifically, in addition to analyzing a printing aspect of the PDF document, the job ticket analysis unit 56 analyzes whether or not a banner print instruction is present (S14). If no such instruction is present, simply the PDF document is printed (S36). In other words, the data-rasterizing unit 68 converts the PDF document into the raster image, which is printed by the output unit 54. On the other hand, if a banner print instruction is present, a determination is made as to whether or not a print instruction for the attribute (value) for the PDF document is provided (S16). If no attribute print instruction is provided, the banner is immediately printed (S34). Specifically, the banner sheet creation unit 62 creates the banner sheet, the data-rasterizing unit 68 converts the banner sheet into the raster image, and the output unit 54 prints it. On the other hand, if an attribute print instruction is provided, a determination is made as to whether a font reference location for the attribute is described in the job ticket (S18). If the font reference location is not described, the banner is printed in a normal printing aspect (S34).

If the font reference location for the attribute is described in the job ticket, a determination is made as to whether or not the PDF document has the font (S20). If the PDF document has the font, information on the font is immediately obtained (S32), and the banner is printed (S34). However, if the PDF document has no font, a determination is made as to whether or not the job ticket indicates an alternative method in the case of no font (S22). If the job ticket does not describe the alternative method, the font is replaced with a string and a font prepared by the system (S24), and information on the font is obtained (S32). On the other hand, if the job ticket describes the alternative method in the case of no font, a determination is made as to whether or not the alternative method instructs use of another string and another font different from the original ones (S26). If the determination result is Yes, an alternative font is retrieved in the PDF document (S28). If the alternative font is present, the font is obtained (S32). On the other hand, if the alternative font is not present, or if the determination result is No in step S26, a determination is made as to whether or not the job ticket has glyph information on the font (S30). If the job ticket has the glyph information, the glyph information is used. If the job ticket has no glyph information, the glyph information is replaced with the string and the font prepared by the system (S24).

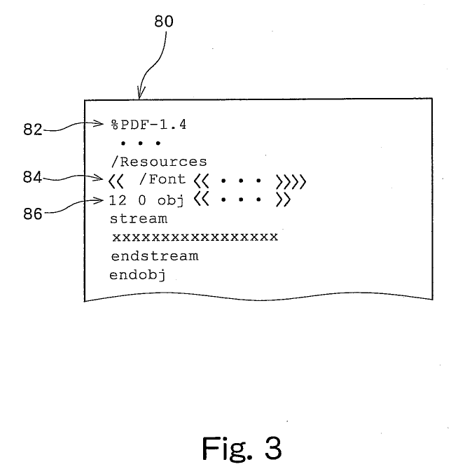

Next, by reference to FIGS. 3 to 6, a specific aspect will be described.

FIG. 3 shows an example of the PDF document serving as the print target. A PDF document 80 shown in FIG. 3 is assigned a file name “SPECIFICATION.pdf.” In the PDF document 80, a header 82 of “% PDF-1.4” indicating that the document is a PDF file is set. Furthermore, in the PDF document 80, there are provided an embedded font 84 embedded as “<</Font << . . . >>>>”, an object 86 for document information described as “12 0 obj . . . endobj”, and the like.

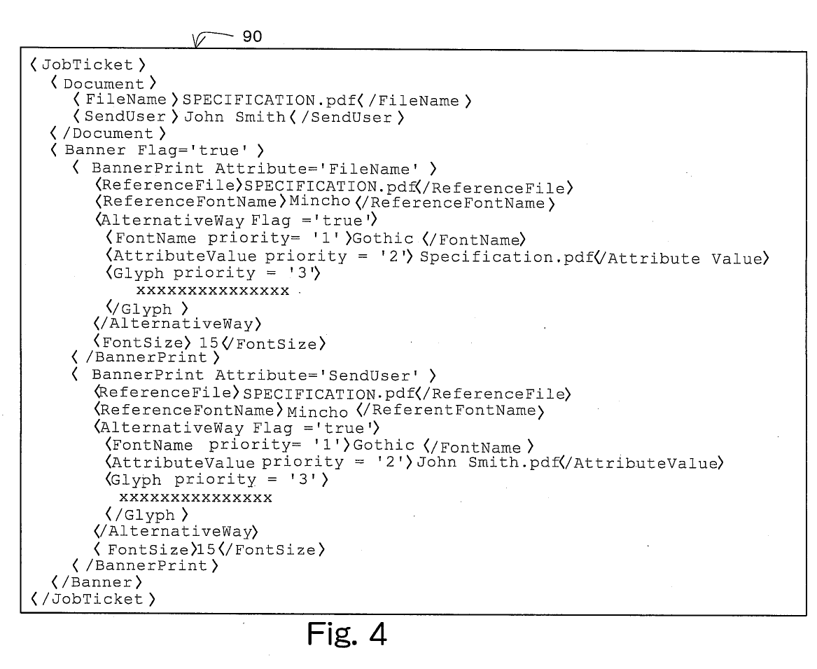

FIG. 4 shows a job ticket 90 for printing the PDF document 80 shown in FIG. 3. In the job ticket 90, for example, general print settings can be described, such as a printer name, the number of copies to print, a color setting, and the like. However, in FIG. 4, such a general print setting description is omitted, and FIG. 4 shows a setting mainly required for the banner printing.

The job ticket 90 is described in XML (Extensible Markup Language), which is a markup language. Text data are structured and have semantics with tags such as <JobTicket>, <Document>, and the like. For example, the <Document> tag sets the print data of a main print target. In the <Document> tag, there are provided a <FileName> tag that sets that the name of the print data is “SPECIFICATION.pdf,” and a <SendUser> tag that sets that a sender's (print requestor's) user name is “John Smith.”

In the job ticket 90, a <Banner> tag that sets the banner printing as the auxiliary printing is further provided. In this <Banner> tag, the banner printing is instructed to be executed by setting “Flag=‘true’,” and not to be executed by setting “Flag=‘false’.” In the <Banner> tag, two <BannerPrint> tags are provided. These <BannerPrint> tags set the attributes which are print items in the banner printing. “Attribute=‘FileName’” is set in one of these tags, and “Attribute=‘SendUser’” is set in the other tag. The former is a setting for printing, on the banner sheet, the value “SPECIFICATION.pdf” of the attribute “FileName” defined in the <Document> section. The latter is a setting for printing, on the banner sheet, the value “John Smith” of the attribute “SendUser” defined in the <Document> section.

In the <BannerPrint> tag having the attribute “FileName” set, there are provided respective tags of <ReferenceFile>, <ReferenceFontName>, <AlternativeWay>, and <FontSize>. Among them, <ReferenceFile> is a tag that defines which file is referred to for obtaining the font used for the attribute printing, and “SPECIFICATION.pdf” is set herein. <ReferenceFontName> is a tag that defines which font is referred to, and “Mincho” is set herein. Therefore, in the case of printing the value “SPECIFICATION.pdf” of the attribute “FileName,” a font of “Mincho” embedded in the file “SPECIFICATION.pdf” is referred to. Specifically, an examination is made as to whether or not the embedded font 84 in the PDF document 80 shown in FIG. 3 is “Mincho.” The embedded font 84 is referred to if it is “Mincho.”

The following <AlternativeWay> tag defines an alternative processing method in the case where a font defined with the <ReferenceFile> and <ReferenceFontName> tags is not found. Here “Flag=‘true’” is given to declare that the alternative processing method is to be set. As the alternative processing method having the highest priority “priority=‘1’,” a processing method of using a font “Gothic” is defined with a <FontName> tag. In other words, if the file “SPECIFICATION.pdf” has no font of “Mincho,” “Gothic” in the same file is set to be sought and used first. The alternative processing method having the second highest priority “priority=‘2’” is set with an <AttributeValue> tag. This <AttributeValue> tag is a tag that sets another value as the value of the attribute of “FileName” set with the <BannerPrint> tag, and is given the value “Specification.pdf.” Therefore, instead of “SPECIFICATION.pdf,” the value “Specification.pdf” is printed in a file name column of the banner sheet. The alternative processing method having the third highest priority “priority=‘3’” is set with a <Glyph> tag. In this <Glyph> tag, specific glyph information “xxxxxxxxxxxxxxx” is set, and the printing is performed on the basis of this glyph information without reference to another file.

The remaining <FontSize> tag defines a print size of the font to be 15 points. Also, in the <BannerPrint> tag having the attribute “SendUser” set, a normally used font and the alternative processing method are similarly set. It should be noted that although the example of setting three processes has been illustrated as the alternative processing method in the case where the font is not found in the normally referenced PDF document, it may be the case that only one of the processing methods is defined. It should be noted that in the case of setting the alternative processing method in this way, at least one processing method having no or a low possibility of causing garbage characters may be prepared.

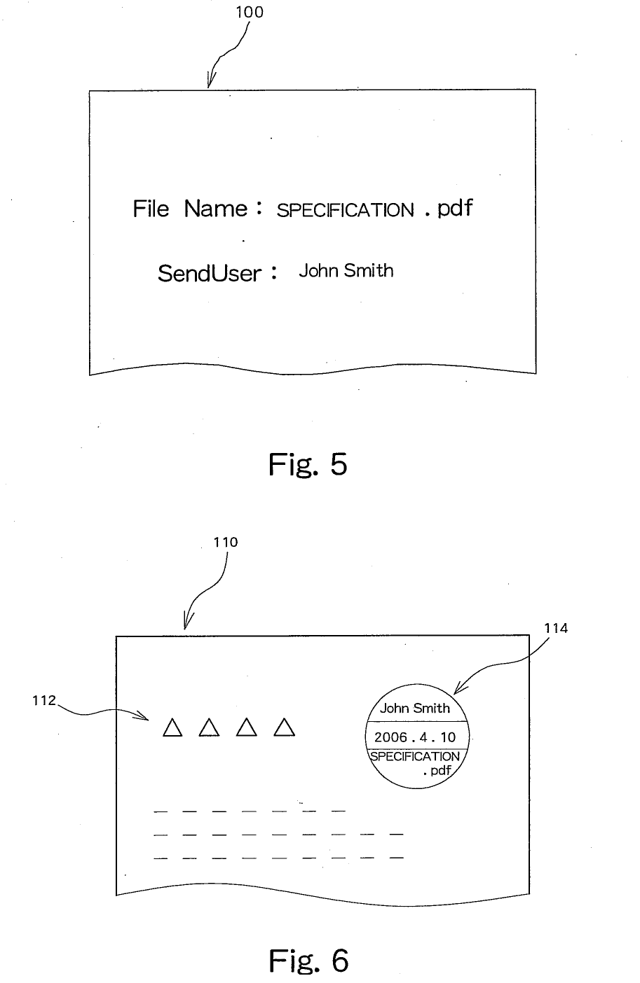

FIG. 5 shows a result of the banner printing performed with the job ticket 90 shown in FIG. 4. The banner sheet 100 shown in FIG. 5 is a sheet printed immediately before printing of the PDF document 80 (SPECIFICATION.pdf) shown in FIG. 3 and output in a manner superimposed on the printing result of the PDF document 80. This banner sheet 100 is created by reflecting the setting of the job ticket 90 on a template. Consequently, as instructed in the job ticket 90, the value “SPECIFICATION.pdf” of the attribute “FileName” and the value “John Smith” of the attribute “SendUser” are printed on the banner sheet 100 in the Mincho font embedded in the “SPECIFICATION.pdf.” The Mincho font is commonplace in Japan, whereas it is not necessarily prepared normally abroad. However, using the font embedded in the “SPECIFICATION.pdf” may ensure execution of the printing, regardless of whether or not the font is installed.

FIG. 6 shows another example of performing the attribute printing. A SPECIFICATION 110 shown in FIG. 6 shows the printing result of the PDF document 80 shown in FIG. 3. In other words, a document 112 corresponding to the object 86 is printed in the SPECIFICATION 110. This SPECIFICATION 110 is characterized by having a stamp 114 printed near the upper right corner. This stamp 114 is synthesized with the PDF document 80 on the basis of a job ticket similar to the job ticket 90 of FIG. 4, and outputted. The stamp 114 includes the value “John Smith” of the attribute “SendUser,” “2006.4.10” as a value of a printing date and time attribute, and the value “SPECIFICATION.pdf” of the attribute “FileName.” In other words, the stamp 114 serves to record who has printed what, and when.

Also in the stamp 114, normal printings cause generation of garbage characters, if the font is not installed in the printer or the print server. In order to prevent generation of the garbage characters, externally obtaining the font during the printing may be considered, which may extend the time required for the printing. In contrast, this aspect of obtaining the font from the PDF document 80 as the main print target can perform a quick and appropriate printing.

Next, various variations of this exemplary embodiment will be described. The following description partially overlaps the above description.

Image-forming control data are data for controlling image-forming in an image-forming apparatus. The image-forming control data may be used by an image-forming requester to issue an image-forming request to the image-forming apparatus or its control apparatus, or may be used by a control apparatus controlling an image-control apparatus to perform the print instruction to this image-forming apparatus. No particular limitation is imposed on a data format of the image-forming control data, and they may be of any format interpretable in the image forming apparatus or its control apparatus. Also, the image-forming control data are typically configured as a single file, but the data may be configured as a data column not configured as a file, or may be configured as multiple files or data columns. An example may include an aspect of forming output target indication data, separately forming auxiliary output target indication data and font indication data, and using and controlling both types of data together in a series of processes.

The output target indication data are data for indicating an electronic file to be output from the image-forming apparatus. In the output target indication data, for example, description of the file name, the URL, and the like identifies the file. As the file identified with the output target indication data (which may be hereinafter referred to as “output target file”), a file having a format capable of embedding the font therein is set. Illustrative examples of such a file include PDF, DocuWorks (registered trademark), and the like.

The auxiliary output target indication data are data for indicating an output target other than the output target file. In the auxiliary output target indication data, the attribute value for the output target file is identified (including the case of indirectly identifying the attribute value by identifying the attribute). In other words, the image-forming apparatus interprets the auxiliary output target indication data to output the attribute value. The attribute value may be output separately from the output target file, or may be synthesized with an output image of the output target file. Here, the output image refers to an image output from the image-forming apparatus and visually recognized by the user. The output image is an image displayed on a screen if the image-forming apparatus is a display apparatus (displayed image), or an image printed on paper if the image-forming apparatus is a printer (printed image). It should be noted that the attribute value is the value of the attribute for the output target file, which can illustratively include the attribute related to the file itself (the file name, a file creation date, a file creator's user name, and the like) and the attribute related to the image forming for the file (for example, an image-forming requestor's user name, an image-forming time and date, and the like).

The font indication data are data for indicating the font embedded in the output target file as a font used for outputting the attribute value. The output target file is input in the image forming apparatus or its control apparatus for outputting the output target file itself. Consequently, the image-forming apparatus or its control apparatus can easily refer to the font embedded in the output target file. Also, the output target file is considered to be likely to have the font representing the attribute value for the output target file embedded. Therefore, the font indication data specify the output target file as the font reference location.

In an aspect of the image-forming control data, the attribute value is synthesized with an output image of the file to be output. A specific aspect can include synthesizing the attribute value in a format such as a header, a footer, a stamp, and the like.

In another aspect of the image-forming control data, the attribute value is output in a banner output immediately before or after the file. The banner aids in understanding of a file output result. If the image-forming operation is printing, a cover sheet superimposed on a file-printing result to be output corresponds to the banner sheet. The banner typically includes an output target file name, an output requestor's user name, and the like.

In another aspect of the image-forming control data, the attribute value is output in an output log report of the image-forming apparatus. The output log report describes a history of file outputs in the past and is output periodically or in accordance with the user's instruction. The output log report typically includes a list of the file name, an output date and time, and the like.

In another aspect of the image-forming control data, if the font indicated by the font indication data is not included, the image-forming control data include alternative glyph indication data that indicate glyph information used for outputting the attribute value. The glyph information is data specifically describing letter shapes, and is created, for example, by expanding the font data and converting them into a bit map. Moreover, in another aspect of the image-forming control data, if the font indicated by the font indication data is not present, the image-forming control data include alternative font indication data that indicate another font embedded in the file or another font embedded in another file as the font used for outputting the attribute value. In addition, in another aspect of the image-forming control data, if the font indicated by the font indication data is not present, the image-forming control data include alternative print target indication data that indicate a string as the output target instead of the attribute value. A font for outputting the alternative string may be effectively indicated as appropriate. It should be noted that if multiple alternative process aspects are indicated, they may be effectively ordered in their priorities of being used.

In another aspect of the image-forming control data, the image-forming control data include font output indication data that indicate a color or a size of the font in outputting the attribute value. In this case, if the font is a scalable font, its font size may be changed for the output. If the font is a fixed-size font, the font of its size may be referred to from the beginning.

In another aspect of the image-forming control data, the image-forming apparatus is a display apparatus that displays the image on a screen. Moreover, in another aspect of the image-forming control data, the image-forming apparatus is a printer that prints the image on paper. The printer may be a complex machine including other image-processing functions. The image-forming control data that control the printing are often referred to as a “job ticket.” Generally, a print output by the printer is performed at a higher resolution than is a display output by the display apparatus, and its output result tends to be used for a long period of time.

The printer can include a unit that receives the image-forming control data, a unit that prints the file indicated by the output target indication data, and a unit that prints the attribute value indicated by the auxiliary output target indication data, in accordance with the font indicated by the font indication data. A print image of the file and the attribute value may be synthesized to be printed. It should be noted that the print output of the output target set by the image-forming control data may be performed with these image-forming control data themselves as a trigger, while the print output may be performed with another type of control data as the trigger. For example, in the case of outputting the attribute value as output log data, its output timing is different from that for the output target file. Therefore, the output timing for an auxiliary output target may be effectively indicated by another type of control data. Similarly, output timing for the output target file may be indicated by another type of control data other than the image-forming control data.

In an aspect of a print server apparatus, the print server apparatus sends the image-forming control data to the printer to control the printing by the printer.

In an aspect of a client apparatus, the client apparatus includes a unit that generates the image-forming control data, and a sending unit that sends the image-forming control data to the printer or the print server apparatus that controls the printer.

It should be noted that the present invention can also be taken as a method executed by the printer, the print server apparatus, or the client apparatus, or as an application program for realizing any of these apparatuses or a storage medium thereof. Also, the present invention can be taken as an invention of a print system having the print server apparatus and the client apparatus integrated therein, or as an invention of a method, a program, and a storage medium of the print system.

The foregoing description of the embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with various modifications as are suited to the particular use contemplated. It is intended that the scope of the invention be defined by the following claims and their equivalents.

What is claimed is:

1. An image-forming apparatus comprising:
an image output unit that outputs an image,
wherein the image output unit has its output controlled with:
output target indication data that indicate a file capable of embedding a font therein as an output target;
auxiliary output target indication data that indicate an attribute value related to the file as an auxiliary output target; and
font indication data that indicate the font embedded in the file as a font used for outputting the attribute value.

2. The image-forming apparatus according to claim 1, wherein the attribute value is a file name of the file.

3. The image-forming apparatus according to claim 1, wherein the attribute value is a user name indicating a creator, an owner, or an output instructor of the file.

4. The image-forming apparatus according to claim 1, wherein the attribute value is synthesized with an output image of the file to be output.

5. The image-forming apparatus according to claim 1, wherein the attribute value is output in a banner output immediately before or after the file.

6. The image-forming apparatus according to claim 5, wherein the attribute value is output in an output log report of the image-forming apparatus.

7. The image-forming apparatus according to claim 1, wherein if the font indicated by the font indication data is not present, the output is controlled with alternative glyph indication data that indicate glyph information used for outputting the attribute value.

8. The image-forming apparatus according to claim 1, wherein if the font indicated by the font indication data is not present, the output is controlled with alternative font indication data that indicate another font embedded in the file or same or another font embedded in another file as the font used for outputting the attribute value.

9. The image-forming apparatus according to claim 1, wherein if the font indicated by the font indication data is not present, the output is controlled with alternative print target indication data that indicate a string as the output target instead of the attribute value.

10. The image-forming apparatus according to claim 1, wherein the output is controlled with font output indication data that indicate a color or a size of the font in outputting the attribute value.

11. The image-forming apparatus according to claim 1, wherein the image output unit is a display apparatus that displays the image on a screen.

12. The image-forming apparatus according to claim 1, wherein the image output unit is a printer that prints the image on paper.

13. The image-forming apparatus according to claim 12, comprising:
a receiving unit that receives the output target indication data, the auxiliary output target indication data, and the font indication data,
wherein the printer comprises:
a unit that prints the file indicated by the output target indication data; and
a unit that prints the attribute value indicated by the auxiliary output target indication data, in accordance with the font indicated by the font indication data.

14. An image-forming control method comprising:
controlling an output with:
output target indication data that indicate a file capable of embedding a font therein as an output target;
auxiliary output target indication data that indicate an attribute value related to the file as an auxiliary output target; and
font indication data that indicate the font embedded in the file as a font used for outputting the attribute value.

15. A computer-readable medium storing a program causing a computer to execute a process for image-forming control, the process comprising:
indicating a file capable of embedding a font therein as an output target;
indicating an attribute value related to the file as an auxiliary output target; and
indicating the font embedded in the file as a font used for outputting the attribute value.

16. A computer data signal embodied in a carrier wave for enabling a computer to perform a process for image-forming control, the process comprising:
indicating a file capable of embedding a font therein as an output target;
indicating an attribute value related to the file as an auxiliary output target; and
indicating the font embedded in the file as a font used for outputting the attribute value.

17. An image-forming control apparatus comprising:
a data generation unit that generates output target indication data that indicate a file capable of embedding a font therein as an output target, auxiliary output target indication data that indicate an attribute value related to the file as an auxiliary output target, and font indication data that indicate the font embedded in the file as a font used for outputting the attribute value; and
a controller that sends the respective generated data to an image-forming apparatus and controls the output by the image-forming apparatus.
